(19) United States
(12) Patent Application Publication
(10) Pub. No.: US 2017/0332831 A1
(43) Pub. Date: Nov. 23, 2017

(54) GRINDER TUMBLER

(71) Applicant: C2 CO., Ltd., Yongin-si (KR)

(72) Inventor: Ki Jong LEE, Hwaseong-si (KR)

(73) Assignee: C2 CO., Ltd., Yongin-si (KR)

(21) Appl. No.: 15/448,985

(22) Filed: Mar. 3, 2017

(30) Foreign Application Priority Data
May 19, 2016 (KR) 10-2016-0061559

(51) Int. Cl. A47J 31/42; A47G 19/22

(52) U.S. Cl. CPC A47J 31/42; A47G 19/2205

(57) ABSTRACT

Provided is a grinder tumbler. The grin tumbler includes a containing unit having a space there inside for receiving and containing, a beans container partially inserted into the containing space of the containing unit and storing coffee beans there inside, a mill being installed inside the beans container and functioning to grind coffee beans, and a covering unit detachably installed to the containing unit while covering the mill.

### CROSS-REFERENCE TO RELATED APPLICATION

This application claims priority under 35 U.S.C. §119 to Korean Patent Application No. 10-2016-0061559 filed on May 19, 2016, the disclosure of which is hereby incorporated by reference in its entirety.

### BACKGROUND

### 1. Field

Embodiments of the present invention relate to a grinder tumbler, and more particularly, to a grinder tumbler aiming to provide a function of grinding coffee beans and also implementing a function of a tumbler.

### 2. Description of Related Art

In these days, features and attraction for enjoying coffee made from coffee beans on behalf of instant coffee are widely spread and increased due to its superior flavor and rich aroma in quality. Therefore, coffee beans-specialized shops and coffee beans-loving drinkers have been increased.

When trying to drink coffee beans at homes or in business offices, it is required to prepare some coffee machine and device for coffee beans and make tiresome efforts in order to drink coffee beans, that is, buying a separate coffee beans grinding apparatus and grinding coffee beans to coffee powder and filtering the coffee powder with water, or buying a separate espresso coffee machine.

It is possible though, to drink coffee beans in where a coffee beans grinding apparatus and a coffee brewing equipment with a filter or an espresso coffee machine are prepared without need to go to coffee beans-specialized shops, but impossible to drink coffee beans in where such machine and device are not prepared, which will lead down to look for coffee beans beverage-selling stores in order to buy a cup of coffee beans beverage.

In case of instant coffee, it can be easily and conveniently drinkable at outdoors or on the way of journeys just by preparing cups, hot water, and instant coffee powder.

However, in comparison with the case of instant coffee, drinking of coffee beans beverage requires additional preparation of coffee beans grinding apparatus and filtering device, or espresso coffee machine, which are relatively greater in volume than for preparation only for instant coffee, and therefore, it is very troublesome or impossible to drink coffee beans beverage by way of separate preparation at outdoors or on the way of journeys.

Prior Art Document

(patent 1) Korean Patent Publication 10-2014-0079584

### SUMMARY

Embodiments of the present invention provide a grinder tumbler for realizing both a coffee beans grinding function for grinding coffee beans by a grinder and a tumbler function together for coffee or beverages to be drinkable.

In accordance with an aspect of the present invention, the grinder tumbler may include a containing unit having a space there inside for receiving and containing, a beans container partially inserted into the containing space of the containing unit and storing coffee beans there inside, a mill being installed inside the beans container and functioning to grind coffee beans, and a covering unit detachably installed to the containing unit while covering the mill.

The containing unit may include a first container, and a second container being inserted into the first container and configured such that a part of the beans container is inserted there into.

The beans container may include a containing member into which the mill is mounted and into which coffee beans is supplied and stored, and a filtering member connectively located under the containing member and allowing ground coffee powder of the coffee beans to be introduced there into and filtered there through.

The mill may include a grinder rotatably installed inside the beans container and grinding coffee beans, and a driving part for supplying rotation driving force to the grinder.

The driving part may include a container lid for covering the containing member, a hand mill rotatably installed to the container lid, and a connector for receiving the rotation driving force from the hand mill and transferring it to the grinder.

The connector may include a rotation axis connected to the grinder, an insertion piece inserted into one end of the rotation axis and rotating together and having a protrusion projected there from, and a link plate fixed to one side of the hand mill and having an insertion hole into which the protrusion is inserted.

The connector may include a rotation axis connected to the grinder, and a fixing part for connecting the rotation axis and the hand mill.

The hand mill may include a first rotation part connected to the fixing part, and a second rotation part slidably connected to the first rotation part with its length controllable.

A guide protrusion may be formed on the surface of the link plate with protruded there from.

The hand mill may include a slider formed to slidably move above from the link plate and having a long-length slide hole into which the guide protrusion is inserted, and a hold lug protruded from the slider, enabling to rotate and functioning to transfer a rotation force to the slider.

In accordance with embodiments of the present invention, a grinding function of grinding coffee beans to coffee powder by using a grinder and a function of allowing to carry and drink beverages of coffee, etc. by using a tumbler anytime and anywhere can be accomplished together in one body of this disclosure, thereby to provide great satisfaction to users.

### BRIEF DESCRIPTION OF THE DRAWINGS

The foregoing and other features and advantages of the present inventions will be apparent from the more particular description of preferred embodiments of the present inventions, as illustrated in the accompanying drawings in which like reference characters refer to the same parts throughout the different views. The drawings are not necessarily to scale, emphasis instead being placed upon illustrating the principles of the present inventions. In the drawings:

FIG. 1 is a perspective view schematically showing a grinder tumbler according to a first embodiment of the present invention;

FIG. 2 is an exploded perspective view schematically showing the grinder tumbler of FIG. 1;

FIG. 3 is a schematic perspective view showing the non-rotation state of the hand mill of the grinder tumbler of FIG. 1;

FIG. 4 is a schematic perspective view showing the rotation state of the hand mill of FIG. 3;

FIG. 5 is a perspective view schematically showing the usage state of the tumbler purpose of the grinder tumbler according to a first embodiment of the present invention;

FIG. 6 is an exploded perspective view schematically showing a grinder tumbler according to a second embodiment of the present invention;

FIG. 7 is a perspective view schematically showing a hand mill including a first rotation part and a second rotation part of the grinder tumbler of FIG. 6;

FIG. 8 is a perspective view schematically showing that the second rotation part of the hand mill of FIG. 7 slides out of the first rotation part;

FIG. 9 is an exploded perspective view schematically showing a grinder tumbler according to a third embodiment of the present invention;

FIG. 10 is a perspective view schematically showing the rotation state of a hand mill of the grinder tumbler of FIG. 9;

FIG. 11 is a perspective view schematically showing the non-rotation state of a hand mill of the grinder tumbler of FIG. 9;

FIG. 12 is a schematic plane view showing that the hand mill is located above a link plate;

FIG. 13 is a schematic plane view showing that the hand mill is slided away from the link plate;

FIG. 14 is a perspective view schematically showing that a connector and a hand mill of a grinder tumbler are connected with each other according to a fourth embodiment of the present invention;

FIG. 15 is a perspective view schematically showing that a second plate of FIG. 14 is slided with respect to a first plate thereof;

FIG. 16 is a perspective view schematically showing that the second plate of FIG. 14 is folded with respect to the first plate thereof;

FIG. 17 is a perspective view schematically showing that a rotation plate and a slider of a grinder tumbler are connected with each other according to a fifth embodiment of the present invention;

FIG. 18 is a perspective view schematically showing that the rotation plate of FIG. 17 is slided;

FIG. 19 is a perspective view schematically showing that the slider of FIG. 17 is rotated and the hand mill is operated;

FIG. 20 is a perspective view schematically showing that a first body and a second body of a grinder tumbler are connected with each other according to a sixth embodiment of the present invention;

FIG. 21 is a perspective view schematically showing the operation state of a hand mill that the second body of FIG. 20 is slided from the first body;

FIG. 22 is a perspective view schematically showing that the second body of FIG. 20 is folded with the first body;

FIG. 23 is a sectional view schematically showing a grinder tumbler according to a seventh embodiment of the present invention; and

FIG. 24 is a perspective view showing the main elements of the grinder tumbler of FIG. 23.

### DETAILED DESCRIPTION OF THE EMBODIMENTS

Since exemplary embodiments of the present invention are provided only for structural and functional descriptions of the present invention, the present invention should not be construed as limited to the embodiments set forth herein. Thus, it will be clearly understood by those skilled in the art that the exemplary embodiments of the present invention may be embodied in different forms and include equivalents that can realize the spirit of the present invention. It should be understood, however, that it is not intended to limit the present invention to the particular forms disclosed, but on the contrary, the present invention is to cover all modifications, equivalents, and alternatives falling within the spirit and scope of the present invention as defined by the appended claims.

It will be understood that, although the terms first, second, etc. may be used herein to describe various elements, components and/or sections, these elements, components, and/or sections should not be limited by these terms. These terms are only used to distinguish one element, component or section from another ones. Thus, a first element, component or part discussed below could be termed a second element, component or part without departing from the teachings of the present invention.

It will be understood that when an element or part is referred to as being “connected to” or “coupled to” another element or part, it can be directly connected or coupled to the other element or part or intervening elements or parts may be present. In contrast, when an element is referred to as being “directly connected to” or “directly coupled to” another element or part, there are no intervening elements or parts present. Meanwhile, spatially relative terms, such as “between” and “directly between” or “adjacent to” and “directly adjacent to” and the like, which are used herein for ease of description to describe one element or feature's relationship to another element(s) or feature(s) as illustrated in the figures, should be interpreted similarly.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless expressly defined in a specific order herein, respective steps described in the present invention may be performed otherwise. That is, the respective steps may be performed in a specified order, substantially at the same time, or in reverse order.

The present invention will now be described more fully hereinafter with reference to the accompanying drawings, in which exemplary embodiments of the present invention are shown.

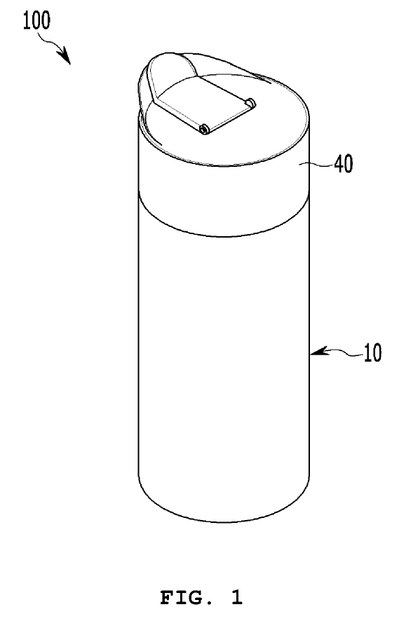

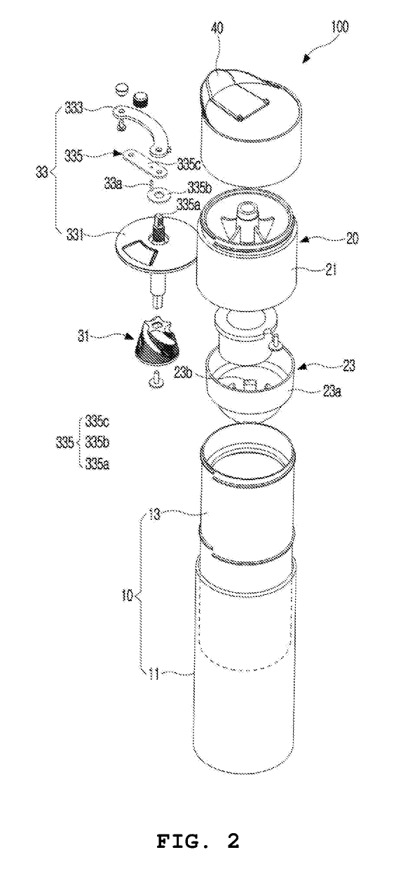

FIG. 1 is a perspective view schematically showing a grinder tumbler according to a first embodiment of the present invention, and FIG. 2 is an exploded perspective view schematically showing the grinder tumbler of FIG. 1.

As shown in FIGS. 1 and 2, a grinder tumbler 100 according to a first embodiment of the present invention includes a containing unit 10 having a space there inside for receiving and containing beverage, a beans container 20 partially inserted into the containing space of the containing unit 10 and storing coffee beans there inside, a mill 30 being installed inside the beans container 20 and functioning to grind coffee beans, and a covering unit 40 detachably installed to the containing unit 10 while covering the mill 30.

The containing unit 10 refers to where beverage such as coffee, etc. is contained inside. The containing unit 10 may include a first container 11, and a second container 13 being inserted into the first container 11 and configured such that a part of the beans container 20 is inserted there into.

The first container 11 may have a cylindrical shape with long length, and functions to support the entire grinder tumbler body at bottom surface. The second container 13 can be inserted into the interior of the first container 11.

The second container 13 can be detachably installed inside the first container 11 by means of screw coupling and the like. Thus, the second container 13 allows to contain the coffee beverage which is made and supplied from the mill 30, which functions to grind coffee beans and will be described in detail below, or contain drinkable beverages there inside chosen by a user's taste and can be used as means for drinking . The beans container 20 is installed inside the second container 13.

In such a structure as above, the mill 30 can grind the coffee beans which is stored inside the beans container 20, and can produce it to coffee powder. The beans container 20 may include a containing member 21 into which the mill 30 can be mounted and into which coffee beans is supplied and stored, and a filtering member 23 connectively located under the containing member 21 and receiving the ground coffee powder there inside, which has been introduced from the containing member 21, and allowing water running there through.

The lower portion of the containing member 21 may be inserted into the containing unit 10, and meantime, inside its upper portion may be the mill 30 installed. The bottom of the containing member 21 is partially opened so that ground coffee powder of coffee beans can be put into the filtering member 23 through its opening.

The filtering member 23 can be fixedly and detachably installed to the containing member 21 through insertion or fitting into its lower portion.

The filtering member 23 may include a filter body 23a to be installed in the lower portion of the containing member 21, and a filter for coffee (not shown) to be inserted into the filter body 23a.

The filter body 23a is installed to be protruded out from the lower portion of the containing member 21, and may have a plurality of openings 23b formed thereon. Through these openings 23b, the coffee powder is filtered and filtered-coffee beverage is moved downward of the containing unit 10. That is, the filter is inserted into the filter body 23a so as to cover the openings 23b of the filter body 23a, and the coffee powder is filtered by the filter and then drinkable coffee beverage flows through the openings 23b and moves downward into the containing unit 10.

The mill 30 may include a grinder 31 rotatably installed inside the containing member 21 and grinding coffee beans, and a driving part 33 for supplying rotation driving force to the grinder 31.

The grinder 31 is rotatably installed inside the containing member 21, being in contact with coffee beans, and can rotate and grind the coffee beans, turning into coffee powder. The grinder 31 receives a driving force for its rotation from the driving part 33, and thus, can be driven to rotate.

The driving part 33 may include a container lid 331 for covering the containing member 21, a hand mill 333 rotatably installed to the container lid 331, and a connector 335 for receiving the rotation driving force from the hand mill 333 and transferring it to the grinder 31.

The container lid 331 can be detachably installed to the containing member 21 and functions to prevent coffee beans and coffee powder from coming out of the containing member 21. To the container lid 331 configured as above, the hand mill 333 is rotatably installed.

The hand mill 333 may be installed in such a configuration and mechanism that a user enables to manually transfer the rotation driving force to the grinder 31 by way of his or her handwork. One end of the hand mill 333 is connected to the connector 335, and the other end of the hand mill 333 is made to extend long beyond the connector 335.

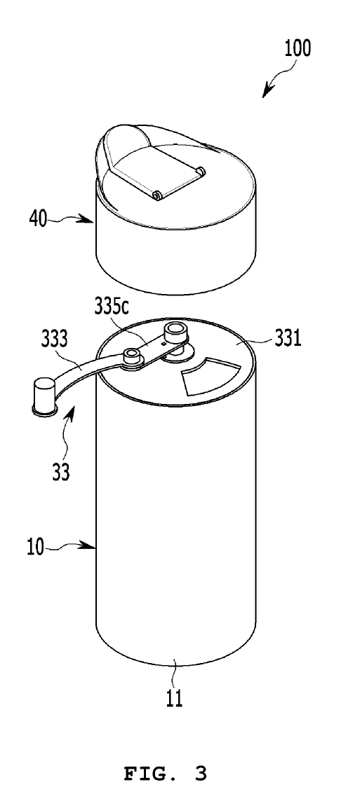

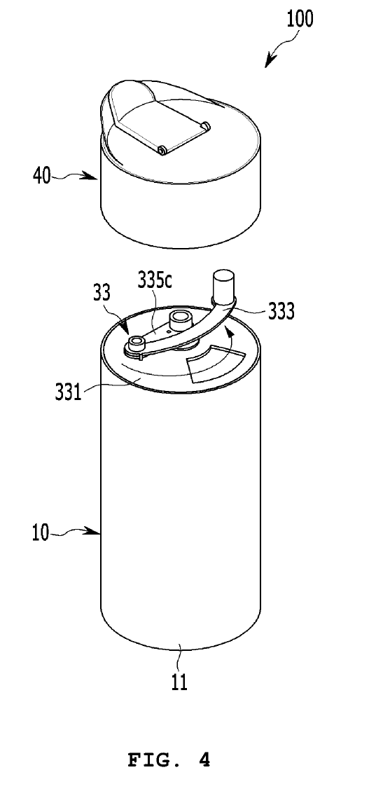

FIG. 3 is a schematic perspective view showing the non-rotation state of the hand mill of the grinder tumbler of FIG. 1, and FIG. 4 is a schematic perspective view showing the rotation state of the hand mill of FIG. 3.

As shown in FIGS. 3 and 4, when a user rotates the hand mill 333 while holding the hand mill 333, the rotation driving force can be transferred to the grinder 31 through the connector 335. Thus, by the rotation of the hand mill 333 in either one direction or reverse direction, the grinder 31 can be selectively rotated inside the containing unit 10, thereby to grind the coffee beans appropriately and well.

The connector 335 may include a rotation axis 335a connected to the grinder 31, an insertion piece 335b inserted into one end of the rotation axis 335a and rotating together and having a protrusion 33a projected there from, and a link plate 335c fixed to one side of the hand mill 333 and having an insertion hole into which the protrusion 33a is inserted.

Because the rotation axis 335a is fixed by coupling means, etc., while one end of the rotation axis 335a is inserted into the grinder 31, the rotation axis 335a can rotate together with the grinder 31. The insertion piece 335b can be fixed to the rotation axis 335a.

The insertion piece 335b may be installed such that it can rotate together with the rotation axis 335a while being inserted into the rotation axis 335a . The insertion piece 335b may be formed as round-shaped plate so as to be inserted into the rotation axis 335a . The protrusion 33a may be formed on one side of the insertion piece 335b with projected there from.

The protrusion 33a is inserted into the link plate 335c so as to interlock the rotation operation of the insertion piece 335b and the link plate 335c. While one protrusion 33a is exemplarily described to be inserted into the link plate 335c here, at least two or more protrusions 33a can be formed to be projected from the insertion piece 335b and fixedly inserted into the link plate 335c.

The link plate 335c can be connected to the insertion piece 335b by the protrusion 33a , and installed to rotate together with the insertion piece 335b , so as to receive a rotation driving force from the hand mill 333 having occurred by user's manual operation and then rotate the rotation axis 335a.

While the link plate 335c is rotatably installed between the containing unit 10 and the covering unit 40, the link plate 335c can be placed with bent and folded in the interior space of the containing unit 10 and the covering unit 40 in non-usage state, but can be operated to move and rotate out of the containing unit 10 in usage state and to transfer the rotation driving force to the grinder 31.

Meanwhile, the mill 30 can be located with put into the inside of the containing unit 10 by the covering unit 40.

The covering unit 40 can be detachably installed to the containing unit 10 while covering the mill 30 and thus, functions to stably protect ground coffee powder or beverage not to be spilt out or discharged out of the grinder tumbler.

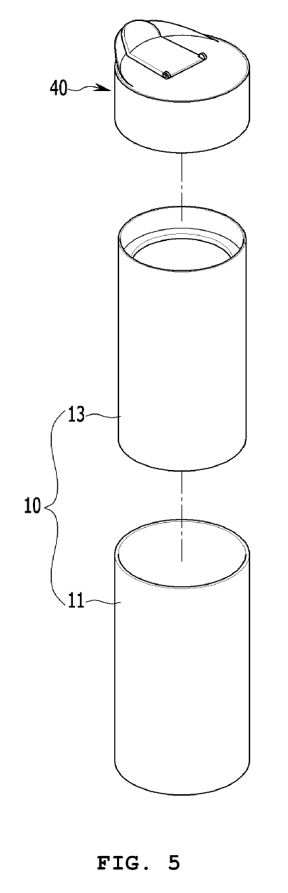

FIG. 5 is a perspective view schematically showing the usage state of the tumbler purpose of the grinder tumbler according to a first embodiment of the present invention.

As shown in FIG. 5, in the state of using only the containing unit 10 and the covering unit 40 of the grinder tumbler 100 by the embodiment of the present invention, it provides the implementation of its tumbler function and portable usage by which it is possible to contain beverage inside the containing unit, and drink it while carrying.

As described above, the grinder tumbler 100 according to a first embodiment of the present invention provides its two purposes being implemented together in that the grinder usage of grinding coffee beans to coffee powder by the grinder 31, and the tumbler usage of allowing to carry and drink beverages including coffee, etc., thereby to incredibly increase the satisfaction of users.

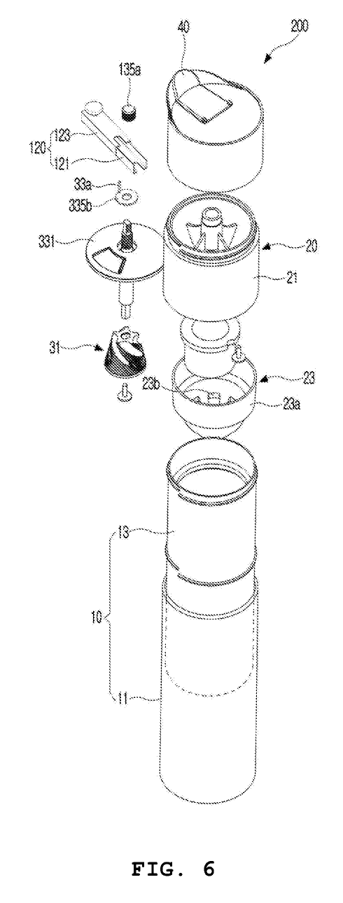

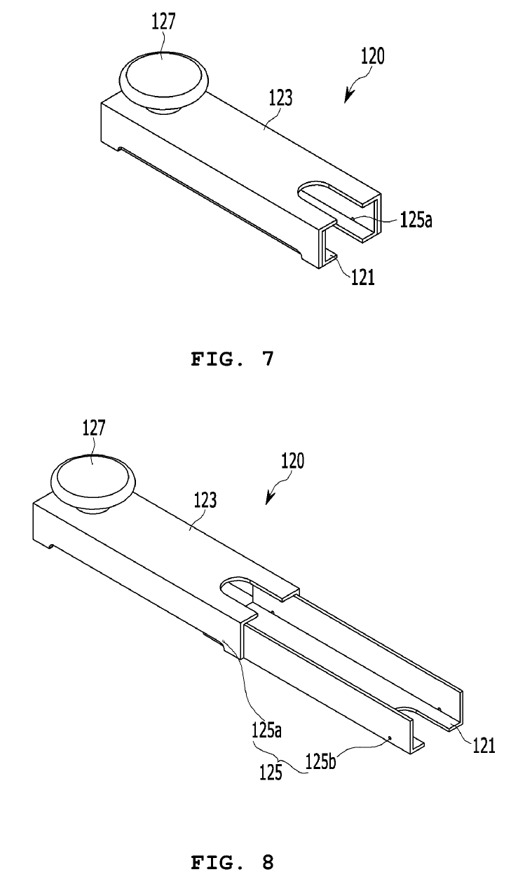

FIG. 6 is an exploded perspective view schematically showing a grinder tumbler according to a second embodiment of the present invention, FIG. 7 is a perspective view schematically showing a hand mill including a first rotation part and a second rotation part of the grinder tumbler of FIG. 6, and FIG. 8 is a perspective view schematically showing that the second rotation part of the hand mill of FIG. 7 slides out of the first rotation part. Same or similar functions or component elements or members may be referred to as same or similar reference numerals in FIGS. 1 to 5. Detailed further description with respect to same reference numerals will be omitted hereinafter.

As shown in FIGS. 6 to 8, a connector 135 of a grinder tumbler 200 according to a second embodiment of the present invention may include a rotation axis 335a connected to a grinder 31, and a fixing part 135a connecting the rotation axis 335a and a hand mill 120.

The fixing part 135a can be applied as a coupling bolt for detachably connecting the hand mill 120 to the rotation axis. The hand mill 120 can be length-controlably connected to the fixing part 135a.

The hand mill 120 includes a first rotation part 121 connected to the fixing part 135a, and a second rotation part 123 slidably connected to the first rotation part 121 and configured to be length-controllable.

The first rotation part 121 is connected with the fixing part 135a at its one end, and meantime, the other end thereof can be extended in long length toward the side direction of a containing unit 10. The second rotation part 123 can be slidably installed to the exterior of the first rotation part 121.

The second rotation part 123 can be installed to the exterior of the first rotation part 121, while enabling to slide there from, and a fixing lock 125 can be formed to fix the location of the second rotation part 123.

The fixing lock 125 may include a catch protrusion 125a formed on the second rotation part 123 with protruded there from, and a fixing hole 125b formed on the first rotation part 121, into which the catch protrusion 125a is inserted.

Therefore, the second rotation part 123 can be slidably moved and fixed by either direction way, that is, outwards to the maximum length out of the first rotation part 121 or inwards to the minimum length covering the exterior of the first rotation part 121, by the configuration of the second rotation part 123 that its catch protrusion 125a is caught and fixed by the fixing hole 125b.

Meanwhile, a rotation handle 127 can be formed on the exterior of the second rotation part 123 with protruded there from and being capable of rotating the hand mill 120. Thus, while a user holding the rotation handle 127, he or she can rotate the hand mill 120 so as to transfer the rotation driving force to a rotation axis 335a.

As described above, since the hand mill 120 is configured such that its length is controllable when the second rotation part 123 is selectively pulled out and made to slidably move outwards from the first rotation part 121, a user can transfer the rotation driving force to the rotation axis 335a more easily while holding the rotation handle 127 and rotating the hand mill. As resulted thereby, the grinding operation of coffee beans can be accomplished more easily and conveniently.

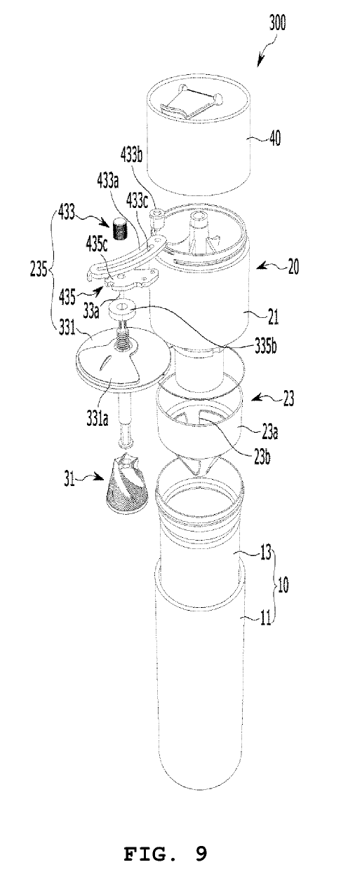

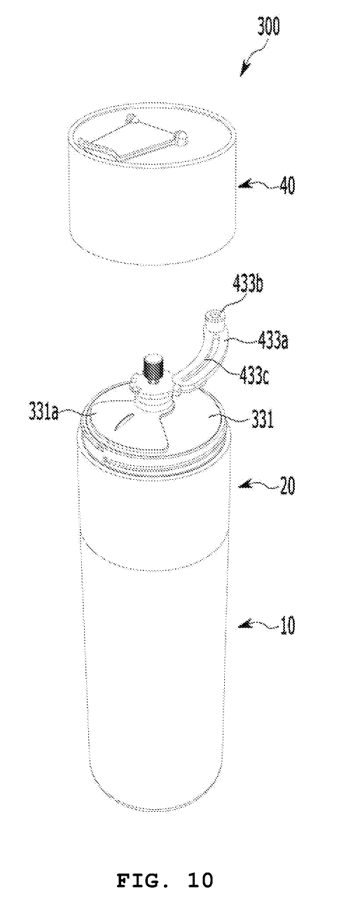

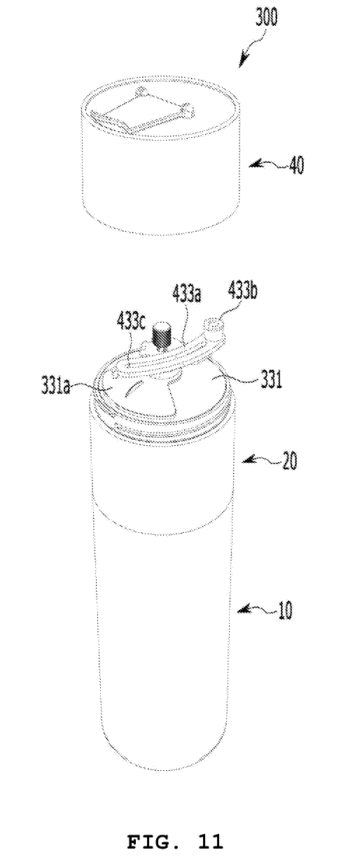

FIG. 9 is an exploded perspective view schematically showing a grinder tumbler according to a third embodiment of the present invention, FIG. 10 is a perspective view schematically showing the rotation state of a hand mill of the grinder tumbler of FIG. 9, and FIG. 11 is a perspective view schematically showing the non-rotation state of a hand mill of the grinder tumbler of FIG. 9. Same reference numerals as those of FIGS. 1 to 8 refer to same or similar elements with same or similar purposes. Hereinafter, detailed description of such same reference numerals will be omitted.

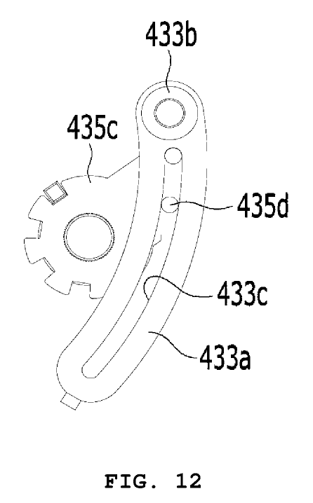

As depicted in FIGS. 9 to 11, a grinder tumbler 300 according to a third embodiment of the present invention exemplarily illustrates a guide protrusion 435d (refer to FIG. 12) formed on the surface of a link plate 435. The guide protrusion 435d may be formed of a pin type which is inserted into the link plate 435. A reference numeral 331a refers to an on-off lid which is opened or closed through which coffee beans is introduced.

A hand mill 433 may include a slider 433a formed to slidably move above from the link plate 435 and having a long-length slide hole 433c into which the guide protrusion 435d is inserted, and a hold lug 433b protruded from the slider 433a , enabling to rotate and functioning to transfer a rotation force to the slider 433a.

The slider 433a may be formed long-extended along its longitudinal direction and curved-shaped with a predetermined angle. Along this longitudinal direction of the slider 433a, the slide hole 433c is formed for the guide protrusion 435d to be inserted there through.

Thus, since the slider 433a can move while being guided by the guide protrusion 435d and being controllable in its length during the process of transferring rotation force to grind the coffee beans by a user, the rotation force can be transferred further easily and more efficiently.

As the hold lug 433b is rotatably formed with protruded from one end edge of the slider 433a, a user can transfer rotation force efficiently to the hand mill 433 while he or she holding the hold lug 433b.

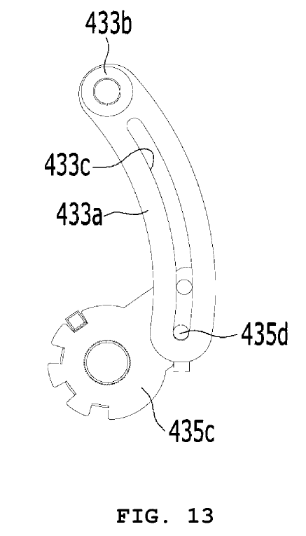

FIG. 12 is a schematic plane view showing that the hand mill is located above the link plate, and FIG. 13 is a schematic plane view showing that the hand mill is slided away from the link plate.

As depicted in FIG. 12, the hand mill 433 is located above the link plate 435 at non-usage state.

Further, as shown in FIG. 13, the hand mill 433 can be slidingly moved away from the end of the link plate 435 in its rotational operation state. Thus, a user can transfer rotation force more efficiently while holding the hold lug 433b of the hand mill 433.

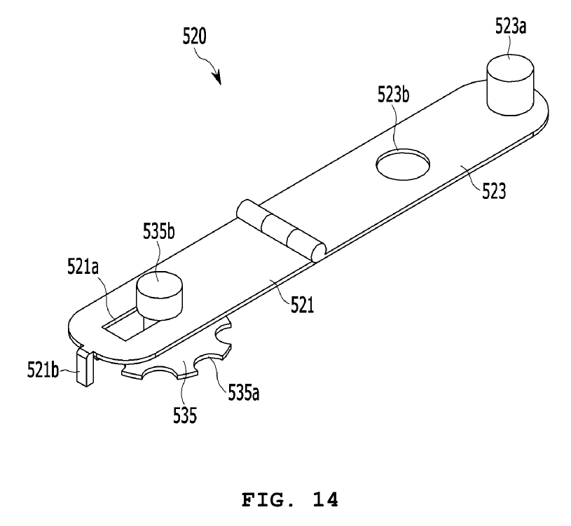

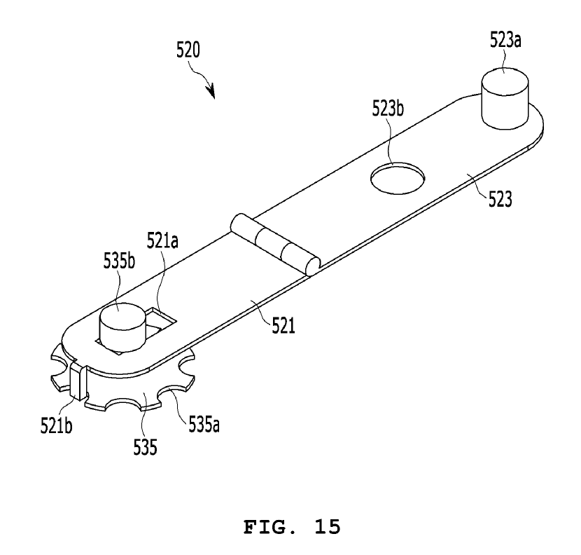

FIG. 14 is a perspective view schematically showing that a connector and a hand mill of a grinder tumbler are connected with each other according to a fourth embodiment of the present invention, FIG. 15 is a perspective view schematically showing that a second plate of FIG. 14 is slided with respect to a first plate thereof, and FIG. 16 is a perspective view schematically showing that the second plate of FIG. 14 is folded with respect to the first plate thereof. Same reference numerals as those of FIGS. 1 to 12 refer to same or similar elements with same or similar purposes. Hereinafter, detailed description of such same reference numerals will be omitted.

As shown in FIGS. 14 to 16, a connector 535 of the grinder tumbler according to a fourth embodiment of the present invention is configured such that it is inserted to and rotates together with a rotation axis 335a (refer to FIG. 2) connected to a grinder 31, and includes a plurality of in-grooves 535a formed along its periphery and an insertion protrusion 535b protruded from its center.

The connector 535 is formed of a gear type, and can rotate together with rotation of the rotation axis 335a while one end of the rotation axis 335a is inserted into the center of the connector 535 and fixed thereby.

The insertion protrusion 535b is formed at the center of the connector 535 with upwardly protruded there from. The insertion protrusion 535b can be inserted into a long-length hole 521a of a first plate 521.

Along the peripheral edge of the connector 535, the in-grooves 535a can be formed radially and plurally with equal interval from each other. Further, a stopper 521b is formed on the first plate 521 of the hand mill 520 and thus, can be selectively caught by one of them. It will be further described in detail below.

The hand mill 520 may include the first plate 521 having the long-length hole 521a through which the insertion protrusion 535b is inserted, and a second plate 523 rotatably installed by the hinge coupling with the first plate 521 at the edge thereof and having a hold lug 523a protruded from the opposite end thereof and an insertion hole 523b for the insertion protrusion 535b to be inserted there through when the second plate 523 is rotated and folded to be in contact with the first plate 521.

The first plate 521 being as a part of the hand mill 520 may have the long-length hole 521a through which the insertion protrusion 535b is inserted. Thus, the first plate 521 can be installed to slidably move as much as the length corresponding to the length of the long-length hole 521a. The second plate 523 can be installed to the first plate 523, being capable of rotated and folded by the way of hinge, etc.

Meanwhile, a stopper 521b may be formed at the first plate 521 to be protruded there from. The stopper 521b can be caught by and fixed to the in-groove 535a, when the first plate 521 is moved toward one side at use of the hand mill 520. Thus, the rotation force of the hand mill 520 is possibly transferred to the grinder by the stopper 521b.

The second plate 523 can be rotatably installed to the protruded end of the first plate 521 by hinge coupling. Thus, the second plate 523 can be unfolded at the usage state of the hand mill 520, and can be folded in contact with the surface of the first plate 521 at non-usage state of the hand mill 520.

As the second plate 523 has the insertion hole 523b formed thereon so that the insertion protrusion 535b can be inserted there through, the second plate 523 can be stably folded without interference of the insertion protrusion 535b.

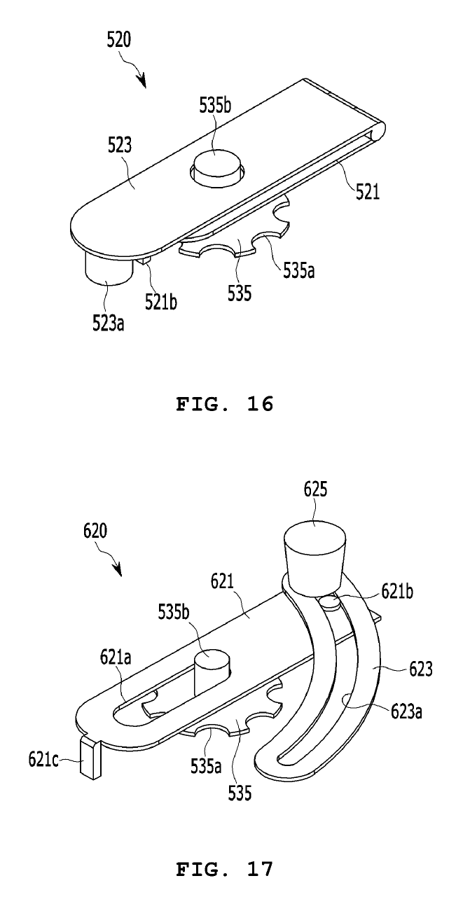

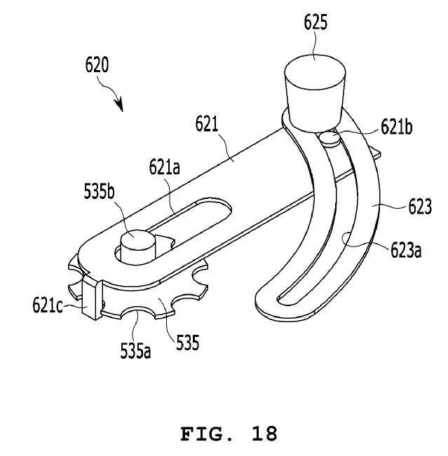

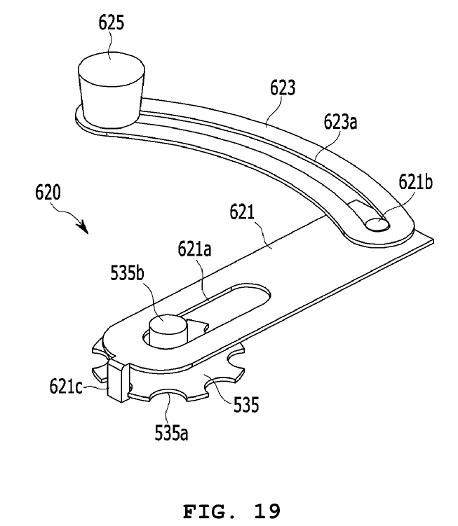

FIG. 17 is a perspective view schematically showing that a rotation plate and a slider of a grinder tumbler are connected with each other according to a fifth embodiment of the present invention, FIG. 18 is a perspective view schematically showing that the rotation plate of FIG. 17 is slided, and FIG. 19 is a perspective view schematically showing that the slider of FIG. 17 is rotated and the hand mill is operated. Same reference numerals as those of FIGS. 1 to 16 refer to same or similar elements with same or similar purposes. Hereinafter, detailed description of such same reference numerals will be omitted.

As shown in FIGS. 17 to 19, a connector 535 of the grinder tumbler according to a fifth embodiment of the present invention is configured such that it is inserted to and rotates together with a rotation axis 335a (refer to FIG. 2) connected to a grinder, and includes a plurality of in-grooves 535a formed along its periphery and an insertion protrusion 535b protruded from its center.

A hand mill 620 may include a rotation plate 621 having a long-length hole 621a through which the insertion protrusion 535b is inserted and a guide protrusion 621b protruded there from, a slider 623 having a long-length slide hole 623a into which the guide protrusion 621b can be inserted and installed to slidably move from the above of the rotation plate 621 downward, and a hold lug 625 protruded from the slider 623, enabling to rotate and functioning to transfer a rotation force to the slider 623. A reference numeral 621c refers to a stopper.

The rotation plate 621 being as a part of the hand mill 620 may have the long-length hole 621a into which the insertion protrusion 535b is inserted. Thus, the rotation plate 621 can be installed to slidably move as much as the length corresponding to the length of the long-length hole 621a.

As above, since the guide protrusion 621b is formed on the upper side of the rotation plate 621, protruded there from, the slider 623 can be installed to slidably move with a predetermined length from the above of the rotation plate 621.

The hold lug 625 is formed on the upper side of the slider 623, protruded there from, and thus, the slider 623 can slidably move downward from the above of the rotation plate 621 as much as up to maximum length while the hand mill 620 is in operation.

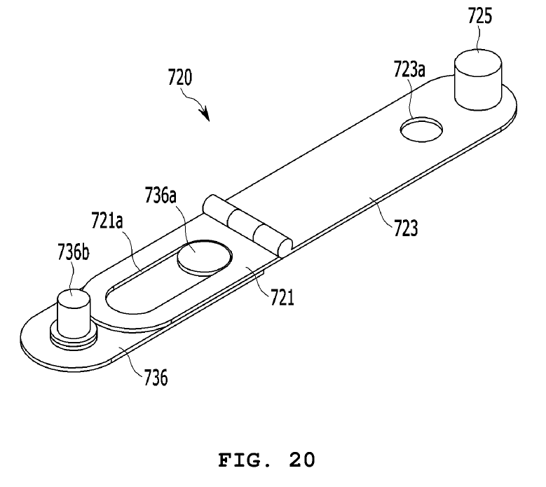

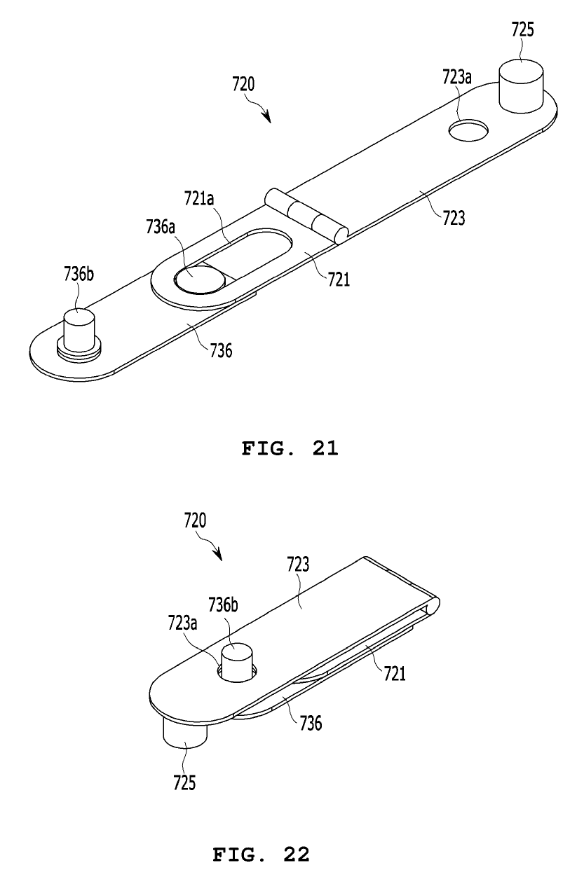

FIG. 20 is a perspective view schematically showing that a first body and a second body of a grinder tumbler are connected with each other according to a sixth embodiment of the present invention, FIG. 21 is a perspective view schematically showing the operation state of a hand mill that the second body of FIG. 20 is slided from the first body, and FIG. 22 is a perspective view schematically showing that the second body of FIG. 20 is folded with the first body. Same reference numerals as those of FIGS. 1 to 19 refer to same or similar elements with same or similar purposes. Hereinafter, detailed description of such same reference numerals will be omitted.

As shown in FIGS. 20 to 22, a connector 735 of a grinder tumbler according to a sixth embodiment of the present invention is configured such that it is inserted to and rotates together with a rotation axis 335a (refer to FIG. 2) connected to a grinder 31, and includes a connect plate 736 having a protrusion 736b protruded from its surface.

The connect plate 736 can rotate together with rotation of the rotation axis 335a while its bottom surface being inserted into the rotation axis 335a . On the connect plate 736 may be formed a stop protrusion 736a to be connected with a first body 721, while being protruded from the surface of the connect plate 736.

The hand mill 720 may include the first body 721 having a long-length hole 721a through which the stop protrusion 736a of the connect plate 736 is inserted, and a second body 723 rotatably installed by the hinge coupling with the first body 721 at the edge thereof and having a hold lug 725 protruded from the opposite end thereof and an insertion hole 723a for the protrusion 736b to be inserted there through when the second body 723 is rotated and folded to be in contact with the first body 721.

The first body 721 has the long-length hole 721a through which the stop protrusion 736a of the connect plate 736 is inserted. Thus, the first body 721 can be installed to slidably move as much as the length corresponding to the length of the long-length hole 721a, so as to enable to control its length to be connected with the connect plate 736. The second body 723 can be rotatably installed to the first body 721 configured as above.

Since the second body 723 can be rotatably installed to the first body 721, it can be rotated with unfolded at usage state, and also can be rotated with folded to the first body 721 at non-usage state. While the second body 723 being folded at non-usage state, the protrusion 736b is inserted into the insertion hole 723a

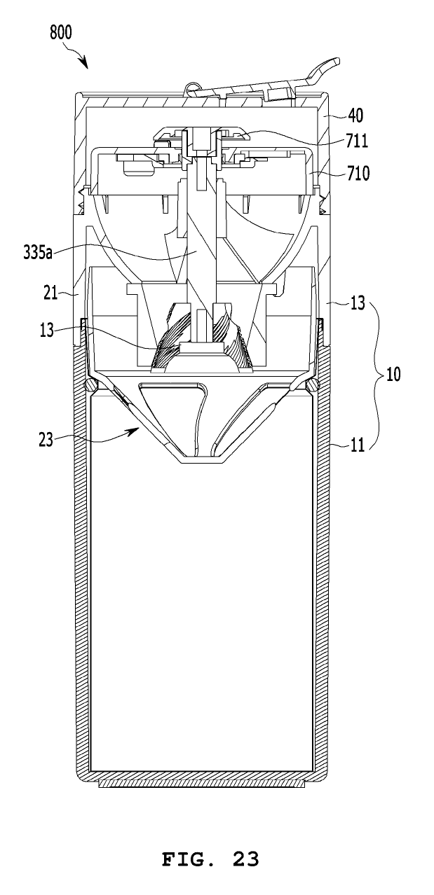

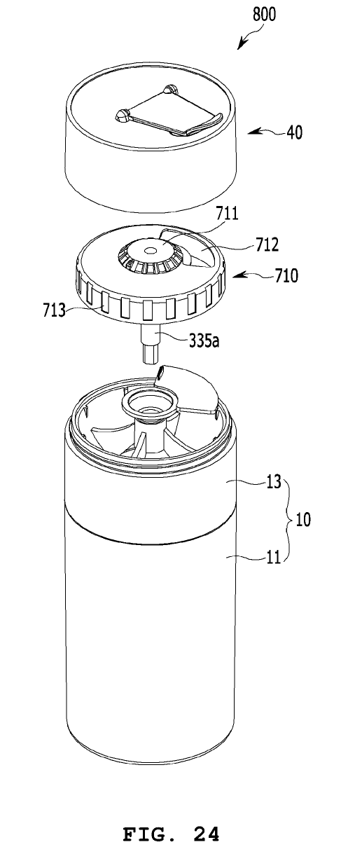

FIG. 23 is a sectional view schematically showing a grinder tumbler according to a seventh embodiment of the present invention, and FIG. 24 is a perspective view showing the main elements of the grinder tumbler of FIG. 23. Same reference numerals as those of FIGS. 1 to 22 refer to same or similar elements with same or similar purposes. Hereinafter, detailed description of such same reference numerals will be omitted.

As shown in FIGS. 23 and 24, a grinder tumbler 800 according to a seventh embodiment of the present invention is configured such that a beans container 20 stores coffee beans there inside, and a mill 30 functions to grind the coffee beans into coffee powder.

The beans container 20 includes a containing member 21 into which the mill 30 can be mounted and into which coffee beans is put, and a filtering member 23 connectively located under the containing member 21 and receiving the ground coffee powder there inside, so as to filter the ground coffee powder. A reference numeral 31 refers to a grinder.

Further, a beans storage box 710 is provided in the containing member 21, and the beans storage box 710 can be opened/closed by a beans storage cover 712.

The beans storage box 710 has a storage space there inside for storing coffee beans, and has a beans rotation lever 713 formed on the side surface thereof. Thus, a user can easily rotate while holding the beans rotation lever 713.

A control screw part 711 is formed on the top of the beans storage box 710. Thus, when rotating the control screw part 711, a rotation axis 335a can be rotated together so as to control the installation position of the beans storage box 710 to the grinder 13.

Therefore, it is possible to control the state that coffee beans is grinded by the grinder 13.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures.

What is claimed is:

1. A grinder tumbler comprising:
a containing unit having a space there inside for receiving and containing;
a beans container partially inserted into the containing space of the containing unit and storing coffee beans there inside;
a mill being installed inside the beans container and functioning to grind coffee beans; and
a covering unit detachably installed to the containing unit while covering the mill, wherein
the containing unit comprises a first container, and a second container being inserted into the first container and configured such that a part of the beans container is inserted there into, and
the beans container comprises a containing member into which the mill is mounted and into which coffee beans is supplied and stored, and a filtering member connectively located under the containing member and allowing ground coffee powder of the coffee beans to be introduced there into and filtered there through, and
the mill comprises a grinder rotatably installed inside the beans container and grinding coffee beans, and a driving part for supplying rotation driving force to the grinder, and
the driving part comprises a container lid for covering the containing member, a hand mill rotatably installed to the container lid, and a connector for receiving the rotation driving force from the hand mill and transferring it to the grinder, and
the connector comprises a rotation axis connected to the grinder, an insertion piece inserted into one end of the rotation axis and rotating together and having a protrusion projected there from, and a link plate fixed to one side of the hand mill and having an insertion hole into which the protrusion is inserted, and
a guide protrusion is formed on the surface of the link plate, and
the hand mill comprises a slider formed to slidably move above from the link plate and having a long-length slide hole into which the guide protrusion is inserted, and a hold lug protruded from the slider, enabling to rotate and functioning to transfer a rotation force to the slider.

2. A grinder tumbler comprising:
a containing unit having a space there inside for receiving and containing;
a beans container partially inserted into the containing space of the containing unit and storing coffee beans there inside;
a mill being installed inside the beans container and functioning to grind coffee beans; and
a covering unit detachably installed to the containing unit while covering the mill, wherein
the containing unit comprises a first container, and a second container being inserted into the first container and configured such that a part of the beans container is inserted there into, and
the beans container comprises a containing member into which the mill is mounted and into which coffee beans is supplied and stored, and a filtering member connectively located under the containing member and allowing ground coffee powder of the coffee beans to be introduced there into and filtered there through, and
the mill comprises a grinder rotatably installed inside the beans container and grinding coffee beans, and a driving part for supplying rotation driving force to the grinder, and
the driving part comprises a container lid for covering the containing member, a hand mill rotatably installed to the container lid, and a connector for receiving the rotation driving force from the hand mill and transferring it to the grinder, and
the connector comprises a rotation axis connected to the grinder, and a fixing part for connecting the rotation axis and the hand mill, and
the hand mill comprises a first rotation part connected to the fixing part, and a second rotation part slidably connected to the first rotation part with its length controllable.

3. A grinder tumbler comprising:
a containing unit having a space there inside for receiving and containing;
a beans container partially inserted into the containing space of the containing unit and storing coffee beans there inside;
a mill being installed inside the beans container and functioning to grind coffee beans; and
a covering unit detachably installed to the containing unit while covering the mill, wherein
the containing unit comprises a first container, and a second container being inserted into the first container and configured such that a part of the beans container is inserted there into, and
the beans container comprises a containing member into which the mill is mounted and into which coffee beans is supplied and stored, and a filtering member connectively located under the containing member and allowing ground coffee powder of the coffee beans to be introduced there into and filtered there through, and
the mill comprises a grinder rotatably installed inside the beans container and grinding coffee beans, and a driving part for supplying rotation driving force to the grinder, and
the driving part comprises a container lid for covering the containing member, a hand mill rotatably installed to the container lid, and a connector for receiving the rotation driving force from the hand mill and transferring it to the grinder, and
the connector comprises a rotation axis connected to the grinder, and a connect plate being inserted into one end of the rotation axis while rotating together with the rotation axis and having a protrusion protruded from the surface thereof, and
the hand mill comprises a first body having a long-length hole into which a stop protrusion of the connect plate is inserted, and a second body rotatably installed to the end of the first body by hinge coupling and having a hold lug protruded from the surface and an insertion hole formed thereon into which the protrusion is inserted when the second body is rotated and folded to be in contact with the first body.
